(19) United States
(12) Patent Application Publication
(10) Pub. No.: US 2024/0205947 A1
(43) Pub. Date: Jun. 20, 2024

(54) RESOURCE ALLOCATION METHOD AND APPARATUS, AND STORAGE MEDIUM

(71) Applicant: Beijing Xiaomi Mobile Software Co., Ltd., Beijing (CN)

(72) Inventor: Qun ZHAO, Beijing (CN)

(73) Assignee: Beijing Xiaomi Mobile Software Co., Ltd., Beijing (CN)

(21) Appl. No.: 18/555,620

(22) PCT Filed: Apr. 16, 2021
(86) PCT No.: PCT/CN2021/087877

§ 371 Date: Oct. 16, 2023

(51) Int. Cl. H04W 72/40; H04W 72/044; H04W 72/25

(52) U.S. Cl. CPC H04W 72/40; H04W 72/044; H04W 72/25

(57) ABSTRACT

The present disclosure relates to a resource allocation method and a device. The resource allocation method is performed by a first user device. The method includes: sending first reserved resource indication information, wherein the first reserved resource indication information is configured for indicating a first reserved resource, and the first reserved resource is a reserved resource used by the first user device for subsequent sending of a Sidelink ranging signal.

### CROSS REFERENCE TO RELATED APPLICATION

The present disclosure is the U.S. national phase application of International Application No. PCT/CN2021/087877 filed on Apr. 16, 2021, the content of which is incorporated herein by reference in its entirety for all purposes.

### BACKGROUND

### Technical Field

The present disclosure relates to the field of communication technology, in particular to a resource allocation method, an apparatus, and a storage medium.

### Description of the Related Art

With the continuous emergence of a new generation of Internet applications, wireless communication technology is driven to evolve constantly to meet the needs of applications.

At present, applications and services based on the distance and the angle between user devices are constantly emerging. By measuring the distance and the angle through wireless signals, a wireless communication capability of the user device can be effectively utilized, and a new capability of the user device can be introduced. Terminals and wireless network devices that support a ranging function can control and operate the measurement of distance and angle more conveniently, and can be applied to a variety of commercial and vertical application scenarios, including commodity display, smart home, smart city, smart transportation, smart retail and so on.

### SUMMARY

According to a first aspect of embodiments of the present disclosure, there is provided a resource allocation method applied to a first user device, the resource allocation method including sending first reserved resource indication information, wherein the first reserved resource indication information is configured to indicate a first reserved resource, and the first reserved resource is a reserved resource used by the first user device for subsequent sending of a Sidelink ranging signal.

According to a second aspect of embodiments of the present disclosure, there is provided a resource allocation apparatus, including a sending unit configured to send first reserved resource indication information, wherein the first reserved resource indication information is configured to indicate a first reserved resource, and the first reserved resource is a reserved resource used by the first user device for subsequent sending of a Sidelink ranging signal.

According to a third aspect of embodiments of the present disclosure, there is provided a resource allocation device, including: a processor; and a memory for storing instructions executable by the processor; and the processor is configured to implement the resource allocation method described in the first aspect or any embodiments of the first aspect.

According to a fourth aspect of embodiments of the present disclosure, there is provided a storage medium that can cause a terminal to implement the resource allocation method described in the first aspect or any embodiments of the first aspect when instructions in the storage medium are executed by a processor of a terminal.

It should be understood that the above general description and the following detailed description are only illustrative and explanatory, and do not limit the present disclosure.

### BRIEF DESCRIPTION OF THE DRAWINGS

The drawings herein are incorporated into and form a part of the description, showing embodiments in accordance with the present disclosure, and served together with the description to explain the principles of the present disclosure.

FIG. 1 is a schematic diagram of a Sidelink communication system according to some embodiments.

FIG. 2 is a flowchart of a resource allocation method according to some embodiments.

FIG. 3 is a flowchart of a resource allocation method according to some embodiments.

FIG. 4 is a flowchart of a resource allocation method according to some embodiments.

FIG. 5 is a schematic diagram of resource allocation according to some embodiments.

FIG. 6 is a flowchart of a resource allocation method according to some embodiments.

FIG. 7 is a flowchart of a resource allocation method according to some embodiments.

FIG. 8 is a flowchart of a resource allocation method according to some embodiments.

FIG. 9 is a block diagram of a resource allocation apparatus according to some embodiments.

FIG. 10 is a block diagram of a device for resource allocation according to some embodiments.

### DETAILED DESCRIPTION OF THE PREFERRED EMBODIMENTS

Exemplary embodiments will be described herein in detail, and examples thereof are shown in the drawings. When the following description refers to the drawings, unless otherwise indicated, the same numerals in different drawings represent the same or similar elements. Embodiments described in the following exemplary embodiments do not represent all embodiments consistent with the present disclosure. On the contrary, they are only examples of devices and methods consistent with some aspects of the present disclosure as detailed in the appended claims.

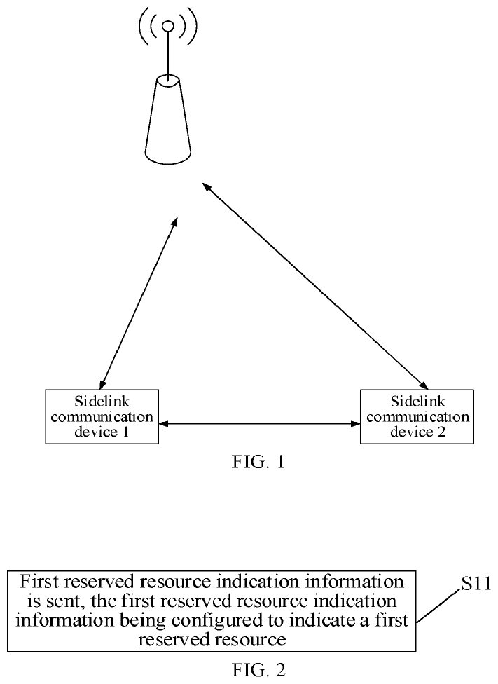

Embodiments of the present disclosure provide a resource allocation method, which can be applied to a Sidelink communication system shown in FIG. 1. As shown in FIG. 1, in the scenario where the Sidelink communication is conducted between Sidelink communication devices, a network device configures various transmission parameters for data transmission for a Sidelink communication device 1. The Sidelink communication device 1 acts as a data sending terminal, and a Sidelink communication device 2 acts as a data receiving terminal. These two terminals communicate directly. The link between the network device and the Sidelink communication device is uplink and downlink, and the link between the Sidelink communication device and the Sidelink communication device is Sidelink.

In the present disclosure, a communication scenario of Sidelink communication between Sidelink communication devices can also be a scenario where the device to device (D2D) communication is conducted. The Sidelink communication device for Sidelink communication in embodiments of the present disclosure can be various devices with wireless communication functions, including handheld devices, on-board devices, wearable devices, computing devices or other processing devices connected to wireless modems, as well as various forms of user equipment (UE), mobile stations (MS), terminals, terminal equipment, and the like. For the convenience of description, embodiments of the present disclosure will be described below, taking the Sidelink communication device as the user device as an example.

At present, physical layer channels in the NR Sidelink communication system include Physical Sidelink Broadcast Channel (PSBCH), Physical Sidelink Shared Channel (PSSCH), Physical Sidelink Control Channel (PSCCH), and Physical Sidelink Feedback Channel (PSFCH). Physical layer reference signals include Primary Sidelink Synchronization Signal (PSSS), Secondary Sidelink Synchronization Signal (SSSS), Demodulation Reference Signal (DMRS), Channel State Information Reference Signal (CSI-RS), Phase Tracking Reference Signal (PT-RS), etc. Since the existing NR Sidelink communication system does not consider the demand for ranging through Sidelink signals, the existing channels or reference signals in the NR Sidelink communication system are not suitable for ranging due to different design purposes. It is necessary to design dedicated Sidelink ranging signals and Sidelink ranging resources for ranging through Sidelink signals.

For Sidelink ranging or positioning, a terminal for sending a ranging signal sends a Sidelink ranging signal, a terminal for receiving a ranging signal performs measurement according to the Sidelink ranging signal, and determines a distance and/or an angle between the sending terminal and the receiving terminal through time measurement or angle measurement. Different from the base station in the NR ranging, which acts as one terminal that positions the transmission and reception of the reference signal, the sending terminal and the receiving terminal in the Sidelink ranging or positioning are both user devices.

In a process of Sidelink ranging, if overlap exists in the time and frequency resources occupied by the Sidelink ranging signals sent by different user devices, the measurement deviation of the ranging signal will be caused and the ranging/positioning accuracy will be affected. When using NR uplink and downlink signals for positioning, the time and frequency resources for positioning signals are configured by the base station, which will ensure that different ranging signals will not cause interference with each other. For the Sidelink, a user device may be within or outside a coverage of the base station. Even if the user device is within the coverage of the base station, it may be in a Radio Resource Control (RRC) idle state. Therefore, for different situations where the user device works within and outside the coverage of the base station, how to allocate resources for Sidelink ranging signals is a subject that needs to be studied.

Embodiments of the present disclosure provide a resource allocation method. In the resource allocation method, a device at a sending end sends a Sidelink ranging signal, reserves resources for sending of the Sidelink ranging signal, and indicates the reserved resources. The user device uses the reserved resources to send the Sidelink ranging signal, so that the allocation of Sidelink ranging resources can be achieved, and possible interference and collision can be reduced.

In embodiments of the present disclosure, for the convenience of description, a sending device that sends the Sidelink ranging signal for Sidelink ranging is referred to as a first user device, a resource reserved by the first user device for sending of the Sidelink ranging signal is referred to as a first reserved resource, and indication information indicating the first reserved resource is referred to as first reserved resource indication information.

FIG. 2 is a flowchart of a resource allocation method according to some embodiments. As shown in FIG. 2, the resource allocation method is performed by the first user device, and includes the following steps.

In step S11, first reserved resource indication information is sent. In some embodiments, the first reserved resource indication information is configured to indicate a first reserved resource. The first reserved resource is the reserved resource used by the first user device for subsequent sending of Sidelink ranging signals.

In embodiments of the present disclosure, the first reserved resource can be a frequency resource, a time resource, or a time and frequency resource, also a code domain resource.

In the resource allocation method provided by embodiments of the present disclosure, the first user device (the device for sending the Sidelink ranging signal) reserves the time resource, and/or the frequency resource, and/or the code domain resource to be used in the future Sidelink ranging signal transmission, so that the subsequent Sidelink ranging signal can be sent by using the first reserved resource being reserved, so as to achieve the resource allocation for Sidelink ranging signals.

In the resource allocation method provided by embodiments of the present disclosure, the first user device can send the first reserved resource indication information by sending Sidelink ranging control information. The Sidelink ranging control information includes indication information (the first reserved resource indication information) of the resource for the sending of the Sidelink ranging signal in the future Sidelink ranging.

In some embodiments, in the resource allocation method provided by embodiments of the present disclosure, the first user device can send the first reserved resource indication information through Sidelink Control Information (SCI).

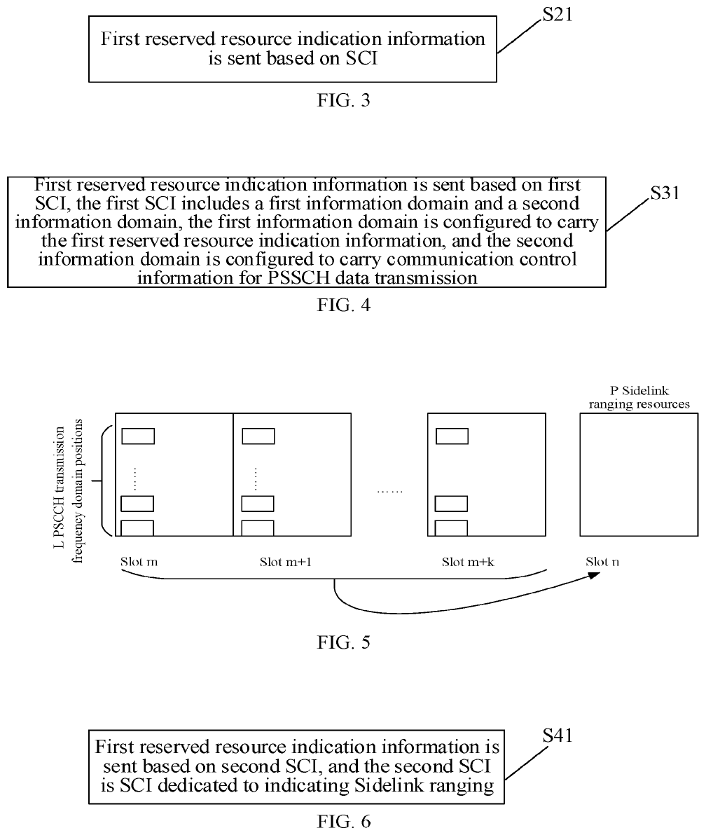

FIG. 3 is a flowchart of a resource allocation method according to some embodiments. As shown in FIG. 3, the resource allocation method is performed by the first user device, and includes the following steps.

In step S21, first reserved resource indication information is sent based on SCI.

In the resource allocation method provided by embodiments of the present disclosure, the first reserved resource indication information is sent based on SCI, and the first reserved resource indicated by the first reserved resource indication information is indicated through SCI.

In embodiments of the present disclosure, the SCI that transmits the first reserved resource indication information and indicates the first reserved resource can be 1st-stage SCI or 2nd-stage SCI. In other words, in the resource allocation method provided by embodiments of the present disclosure, the first reserved resource indication information can be carried in the 1st-stage SCI, and also the first reserved resource indication information can be carried in the 2nd-stage SCI.

In embodiments of the present disclosure, when sending the first reserved resource indication information through SCI, the first reserved resource indication information can be sent based on the existing SCI configured to carry Physical Sidelink Shared Channel (PSSCH) data transmission. In embodiments of the present disclosure, new SCI dedicated to the Sidelink ranging can also be provided, and the first reserved resource indication information can be sent through the new SCI dedicated to the Sidelink ranging.

In the resource allocation method provided by embodiments of the present disclosure, when sending the first reserved resource indication information based on the existing SCI configured to carry communication control information for PSSCH data transmission, a new information field can be added. The first reserved resource indication information is carried in the new information field.

In embodiments of the present disclosure, for the convenience of description, the SCI with a new information field added and configured to indicate the first reserved resource is referred to as first SCI. The newly added information field is referred to as a first information field, which is configured to carry the first reserved resource indication information. An information field originally configured to carry the communication control information for PSSCH data transmission is referred to as a second information field.

FIG. 4 is a flowchart of a resource allocation method according to some embodiments. As shown in FIG. 4, the resource allocation method is performed by the first user device, and includes the following steps.

In step S31, first reserved resource indication information is sent based on first SCI.

In some embodiments, the first SCI includes a first information field and a second information field. The first information field is configured to carry the first reserved resource indication information, and the second information field is configured to carry the communication control information for PSSCH data transmission.

In the resource allocation method provided by embodiments of the present disclosure, sending the first reserved resource indication information through the first SCI can include carrying the reserved resource information for ranging in the 1st-stage SCI transmitted through the PSCCH physical layer channel.

In some embodiments, a new information field (the first information field) can be added without changing the information field (the second information field) of the existing SCI format 1-A. The new information field can indicate reserved future ranging resource. That is, in the resource allocation method provided by embodiments of the present disclosure, the PSCCH transmitting the 1st-stage SCI can be associated with the Sidelink PSSCH (carrying the communication control information for PSSCH data transmission), and can also reserve the positioning and ranging resource for the Sidelink ranging (carrying the first reserved resource indication information).

In some embodiments, a new information field (the first information field) can also be added without changing the information field (the second information field) of the existing 2nd-stage SCI. The reserved future ranging resource can be indicated in the new information field. That is, in the resource allocation method provided by embodiments of the present disclosure, the PSSCH transmitting the 2nd-stage SCI can carry the communication control information for PSSCH data transmission, and can also carry the first reserved resource indication information.

In the resource allocation method provided by embodiments of the present disclosure, the first information field includes a reserved bit in the first SCI. That is, the reserved bit in the first SCI is used as the first information field, so as to carry the first reserved resource indication information to indicate the first reserved resource.

In the resource allocation method provided by embodiments of the present disclosure, when carrying the first reserved resource indication information and indicating the first reserved resource based on the first SCI, the first reserved resource can be indicated in at least one of the following ways according to the resource allocation method provided by embodiments of the disclosure:

Way 1, the first reserved resource is explicitly indicated through a bit included in the first information field.

Way 2, the first reserved resource is implicitly indicated through a time-frequency resource position of Physical Sidelink Control Channel (PSCCH) for transmitting the first SCI. For example, the first reserved resource can be implicitly indicated through the time-frequency resource position of the PSCCH transmission for the 1st-stage SCI.

Way 3, the first reserved resource is implicitly indicated through a time-frequency resource position of PSSCH associated with the Physical Sidelink Control Channel (PSCCH) for transmitting the first SCI. For example, the first reserved resource can be implicitly indicated through the time-frequency resource position of the PSSCH associated with the PSCCH for the 1st-stage SCI.

Way 4, the first reserved resource is implicitly indicated through a time-frequency resource of the PSSCH for transmitting the first SCI. For example, the first reserved resource is implicitly indicated through the time-frequency resource for the PSSCH for the 2nd-stage SCI.

Way 5, the first reserved resource is implicitly indicated through a reserved time-frequency resource position for data transmission in the first SCI.

In some embodiments, the first reserved resource is explicitly indicated through the 1st-stage SCI, or implicitly indicated through the time-frequency resource used in sending of the 1st-stage SCI, or implicitly indicated through the time-frequency resource position used by the PSCCH transmission for transmitting the 1st-stage SCI, or implicitly indicated through the reserved time-frequency resource position reserved by the 1st-stage SCI for data transmission.

In some embodiments, the first reserved resource is explicitly indicated through the 2nd-stage SCI, or implicitly indicated through the time-frequency resource used in sending of the 2nd-stage SCI, or implicitly indicated through the time-frequency resource position used by the PSSCH transmission for transmitting the 2nd-stage SCI, or implicitly indicated through the reserved time-frequency resource position reserved by the 2nd-stage SCI for data transmission.

In some embodiments of the present disclosure, the 1st-stage SCI is taken as an example for illustration. Due to the limited information capacity of the 1st-stage SCI, the number of bits for the ranging control information included in the 1st-stage SCI is small (e.g., 1, 2, 3, or 4 bits). In some embodiments, the reserved resources can be indicated through combination of explicit bits and implicit indication.

As shown in FIG. 5, the PSCCH in k slots corresponds to P ranging resources in next j slots (as shown, j=1). The P ranging resources can be multiplexed through time division, frequency division or code division. In some embodiments, the frequency division multiplexing includes the comb frequency division multiplexing. Each slot of the k slots has L possible PSCCH transmission frequency domain positions. There are a total of k*L possible PSCCH transmission time-frequency positions in the k slots. In some embodiments, the ranging resource can be indicated by using one or a combination of the following examples:

Example 1, explicit bit indication. For example, ceil[log 2 (P)] bits are used to indicate which resource is occupied in the P resources.

Example 2, explicit bit+implicit indication. For example, one-bit information is used to explicitly indicate whether to send a Sidelink ranging signal in a specific slot. A position of the specific slot is implicitly determined through a slot and/or a subchannel used when the SCI is sent. For example, a slot with (pre) configured ranging time-frequency resource that is closest to a slot used in sending of the SCI and meets a minimum delay requirement is determined. Alternatively, a specific ranking resource index in a specific slot is determined according to a slot and a subchannel index.

Example 3, a period of the reserved ranging resource is explicitly indicated through additional bit information.

Example 4, a time deviation between a slot of the reserved ranging resource and a slot of SCI, or a deviation value of the ranging resource index, etc., is explicitly indicated through additional bit information.

In the resource allocation method provided by embodiments of the present disclosure, the first reserved resource indication information can also be sent based on SCI dedicated to indicating the Sidelink ranging. For the convenience of description, the SCI dedicated to indicating the Sidelink ranging is referred to as second SCI.

FIG. 6 is a flowchart of a resource allocation method according to some embodiments. As shown in FIG. 6, the resource allocation method is performed by the first user device, and includes the following steps.

In step S41, first reserved resource indication information is sent based on second SCI.

In some embodiments, the second SCI is SCI dedicated to indicating the Sidelink ranging. In some embodiments of the present disclosure, the second SCI can carry the first reserved resource indication information, or other information indicating the Sidelink ranging that is different from the first reserved resource indication information.

In the resource allocation method provided by embodiments of the present disclosure, the second SCI is SCI dedicated to indicating Sidelink ranging, that is, the second SCI is not used to indicate PSSCH data transmission and resource reservation. In some embodiments, the second SCI can adopt the same Sidelink transmission channel format as the SCI indicating the PSSCH data transmission and resource reservation, and/or multiplex the same time and frequency resources. For the convenience of description, the SCI indicating the PSSCH data transmission and resource reservation is referred to as a third SCI.

In the resource allocation method provided by embodiments of the present disclosure, the second SCI is SCI dedicated to indicating the Sidelink ranging, and the third SCI is SCI for indicating the PSSCH data transmission.

In some embodiments, the second SCI and the third SCI have the same Sidelink transmission channel formats, and the second SCI and the third SCI multiplex the same time and frequency resources. That is, the second SCI and the third SCI are transmitted using the same Sidelink transmission channel formats (such as the PSCCH format). Both the second SCI and the third SCI can use the same set of time and frequency resources for transmission. In some embodiments, when loads of the second SCI and the third SCI are different, the loads of the two SCIs can be made to be the same through zero padding.

In the resource allocation method provided by embodiments of the present disclosure, when the second SCI and the third SCI have the same Sidelink transmission channel formats, and the second SCI and the third SCI multiplex the same time and frequency resources, an information field dedicated to indicating that the SCI is dedicated to the Sidelink ranging can be included in the PSCCH transmission process, so that a subsequent terminal receiving the Sidelink ranging signal can determine the second SCI carried in the PSCCH through the information field for indicating that the SCI is dedicated to the Sidelink ranging.

In some embodiments, a new 1st-stage SCI format is designed to indicate the reserved resource for ranging. The new format cannot be used to indicate the PSSCH data transmission and resource reservation. The new 1st-stage SCI format used to indicate the reserved resource for ranging and the 1st-stage SCI format used to indicate the PSSCH data transmission and resource reservation use the same Sidelink transmission channel formats (such as PSCCH format) for transmission. The two SCIs can use a shared set of PSCCH time and frequency resources for transmission. When loads of the two SCIs are different, the two loads can be made to be the same through zero padding. The New 1st-stage SCI format includes an information field indicating that the SCI is used for reserved ranging resources. The terminal receiving the Sidelink ranging signal determines the 1st-stage SCI format carried in the PSCCH by detecting the information field.

In some embodiments, a new 2nd-stage SCI format is designed to indicate the reserved resource for ranging. The new format cannot be used to indicate the PSSCH data transmission and resource reservation. The new 2nd-stage SCI format used to indicate the reserved resource for ranging and the 2nd-stage SCI format used to indicate the PSSCH data transmission and resource reservation use the same Sidelink transmission channel formats (such as PSSCH format) for transmission. The two SCIs can use a shared set of PSSCH time and frequency resources for transmission. When loads of the two SCIs are different, the two loads can be made to be the same through zero padding. The new 2nd-stage SCI format includes an information field indicating that the SCI is used for reserved ranging resources. The terminal receiving the Sidelink ranging signal determines the 2nd-stage SCI format carried in the PSSCH by detecting the information field.

In some embodiments, the second SCI and the third SCI have the same Sidelink transmission channel formats, and the second SCI and the third SCI use different time and frequency resources. That is, the second SCI and the third SCI use different sets of time and frequency resources for transmission. In some embodiments, when the second SCI and the third SCI use the same Sidelink transmission channel formats, the terminal receiving the Sidelink ranging signal can determine through different time and frequency resources whether the SCI that is transmitted is the second SCI format or the third SCI format.

In some embodiments, a new 1st-stage SCI format is designed to indicate the reserved resource for ranging. The new format cannot be used to indicate the PSSCH data transmission and resource reservation. The New 1st-stage SCI format used to indicate the reserved resource for ranging and the 1st-stage SCI format used to indicate the data transmission and resource reservation use different sets of PSCCH time and frequency resources for transmission. When the two SCIs use the same transmission channel formats, the user device for receiving signals can determine through different time and frequency resources which kind of the 1st-stage SCI format is transmitted.

In some embodiments, a new 2nd-stage SCI format is designed to indicate the reserved resource for ranging. The new format cannot be used to indicate the PSSCH data transmission and resource reservation. The new 2nd-stage SCI format used to indicate the reserved resource for ranging and the 2nd-stage SCI format used to indicate the data transmission and resource reservation use different sets of PSSCH time and frequency resources for transmission. When the two SCIs use the same transmission channel formats, the user device for receiving signals can determine through different time and frequency resources which kind of the 2nd-stage SCI format is transmitted.

The resource allocation method provided by embodiments of the present disclosure can carry the first reserved resource indication information and indicate the first reserved resource based on SCI, for example, the 1st-stage SCI and/or the 2nd-stage SCI.

In some embodiments, the resource allocation method provided by embodiments of the present disclosure can also send the first reserved resource indication information based on Media Access Control (MAC) Control Element (CE).

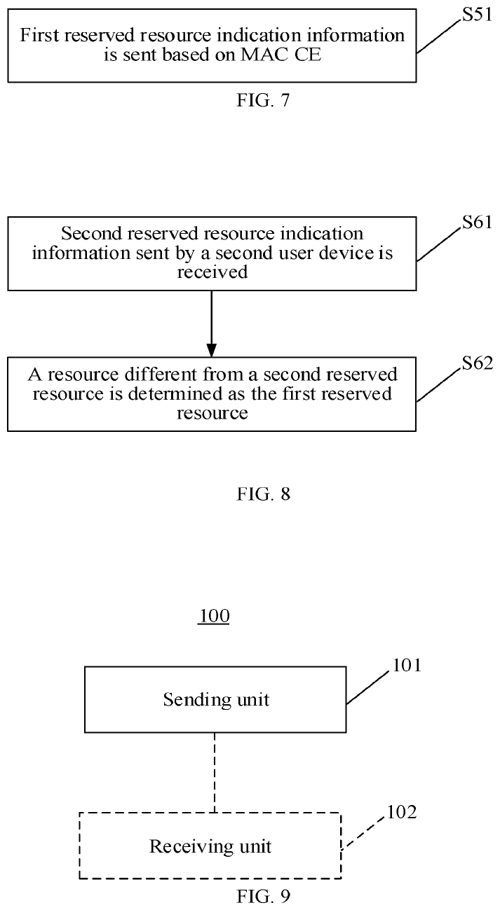

FIG. 7 is a flowchart of a resource allocation method according to some embodiments. As shown in FIG. 7, the resource allocation method is performed by the first user device, and includes the following steps.

In step S51, first reserved resource indication information is sent based on MAC CE.

In the resource allocation method provided by embodiments of the present disclosure, the MAC CE can carry the first reserved resource indication information and indicate the first reserved resource.

In the resource allocation method provided by embodiments of the present disclosure, when determining the first reserved resource for sending the Sidelink ranging information, the first user device can receive the reserved resource indication information (hereinafter referred to as second reserved resource indication information) sent by other devices (hereinafter referred to as second user device) sending the Sidelink ranging signal, to avoid resource conflict, interference and collision. The first reserved resource can be determined based on a second reserved resource indicated by the second reserved resource indication information.

FIG. 8 is a flowchart of a resource allocation method according to some embodiments. As shown in FIG. 8, the resource allocation method is performed by the first user device, and includes the following steps.

In step S61, second reserved resource indication information sent by a second user device is received. In some embodiments, the second user device is another device different from the first user device, and the second user device sends the Sidelink ranging signal. The second reserved resource indication information is used to indicate a second reserved resource, and the second reserved resource is a reserved resource used by the second user device for subsequent sending of the Sidelink ranging signal.

In step S62, a resource different from a second reserved resource is determined and is used as the first reserved resource. In the resource allocation method provided by embodiments of the present disclosure, the first user device determines a resource different from the second reserved resource, as the first reserved resource, so that the conflict between the reserved resources used in the subsequent sending of the Sidelink ranging signal can be avoided, and thus reducing chances of interference and collision.

According to the resource allocation method provided by embodiments of the present disclosure, the device (the first user device) that sends the Sidelink ranging signal reserves resources for the sending of the Sidelink ranging signal and instructs the reserved resources. The first user device uses the reserved resource to send the Sidelink ranging signal, so that the allocation of Sidelink ranging resources can be achieved, and possible interference and collision can be reduced.

It should be noted that those skilled in the art can understand that various implementations/embodiments involved in the above embodiments of the present disclosure can be used in conjunction with the aforementioned embodiments or independently. Whether used alone or in combination with the foregoing embodiments, the implementation principle thereof is similar. In embodiments of the present disclosure, some of the embodiments are described in the way of being used together. Those skilled in the art can understand that such embodiments are not limitations to the present disclosure.

Based on the same ideas, embodiments of the present disclosure also provide a resource allocation apparatus.

It can be understood that the resource allocation apparatus provided by embodiments of the present disclosure include a hardware structure and/or a software module corresponding to each function in order to realize the above functions. In combination with the units and algorithm steps in examples disclosed in embodiments of the present disclosure, embodiments of the present disclosure can be implemented in the form of hardware or a combination of hardware and computer software. Whether a function is implemented in the way of hardware or computer software driving the hardware depends on a specific application and design constraints of a technical solution. Those skilled in the art can use different methods to implement the described functions for each specific application, but such an implementation should not be considered beyond the scope of technical solutions of embodiments of the present disclosure.

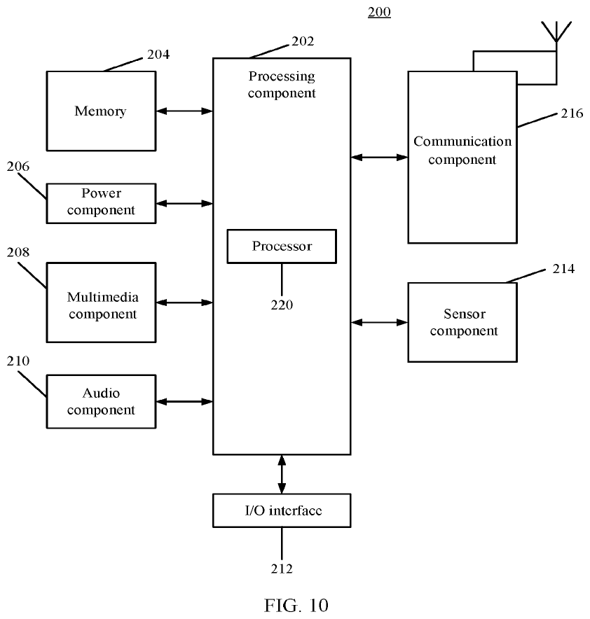

FIG. 9 is a block diagram of a resource allocation apparatus according to some embodiments. Referring to FIG. 9, the resource allocation apparatus 100 includes a sending unit 101.

In some embodiments, the sending unit 101 is configured to send first reserved resource indication information, the first reserved resource indication information being configured to indicate a first reserved resource, and the first reserved resource being a reserved resource used by the first user device for subsequent sending of a Sidelink ranging signal.

In some embodiments, the sending unit 101 sends the first reserved resource indication information based on SCI.

In some embodiments, the sending unit 101 sends the first reserved resource indication information based on first SCI. The first SCI includes a first information field and a second information field. The first information field is configured to carry the first reserved resource indication information, and the second information field is configured to carry communication control information for Physical Sidelink Shared Channel (PSSCH) data transmission.

In some embodiments, the first information field includes a reserved bit in the first SCI.

In some embodiments, the reserved resource is explicitly or implicitly indicated in at least one of the following ways.

The reserved resource is explicitly indicated through the bit included in the first information field. The reserved resource is implicitly indicated through a time-frequency resource position of Physical Sidelink Control Channel (PSCCH) for transmitting the first SCI. The reserved resource is implicitly indicated through a time-frequency resource position of PSSCH associated with the Physical Sidelink Control Channel (PSCCH) for transmitting the first SCI. The reserved resource is implicitly indicated through a time-frequency resource of the PSSCH for transmitting the first SCI. The reserved resource is implicitly indicated through a reserved time-frequency resource position for data transmission in the first SCI.

In some embodiments, the sending unit 101 sends the first reserved resource indication information based on second SCI, the second SCI being SCI dedicated to indicating the Sidelink ranging.

In some embodiments, the second SCI and third SCI have the same Sidelink transmission channel formats, and the second SCI and the third SCI multiplex the same time and frequency resources. The third SCI is SCI configured to indicate PSSCH data transmission, and the second SCI is SCI dedicated to indicating the Sidelink ranging.

In some embodiments, the second SCI and the third SCI have the same Sidelink transmission channel formats, and the second SCI and the third SCI use different time and frequency resources. The third SCI is SCI configured to indicate PSSCH data transmission.

In some embodiments, SCI includes 1st-stage SCI and/or 2nd-stage SCI.

In some embodiments, the sending unit 101 sends the first reserved resource indication information based on MAC CE.

In some embodiments, the resource allocation apparatus 100 further includes a receiving unit 102 configured to receive second reserved resource indication information sent by a second user device. In some embodiments, the second user device is another device sending the Sidelink ranging signal different from the first user device, the second reserved resource indication information is configured to indicate a second reserved resource, and the second reserved resource is a reserved resource used by the second user device for subsequent sending of the Sidelink ranging signal. The receiving unit 102 is further configured to determine a resource different from the second reserved resource as the first reserved resource.

As for the apparatus in the above embodiments, specific ways in which each module performs the function has been described in detail in the method embodiments, which will not be described in detail here.

FIG. 10 is a block diagram of a device 200 for resource allocation according to some embodiments. The device 200 for resource allocation can be provided as the user device involved in embodiments described above. For example, the device 200 can be a mobile phone, a computer, a digital broadcasting user device, a messaging device, a game console, a tablet device, a medical device, a fitness device, a personal digital assistant, etc.

Referring to FIG. 10, device 200 can include at least one of the following components: a processing component 202, a memory 204, a power component 206, a multimedia component 208, an audio component 210, an input/output (I/O) interface 212, a sensor component 214, and a communication component 216.

The processing component 202 typically controls the overall operation of the device 200, such as operations associated with display, telephone call, data communication, camera operation, and recording operations. The processing component 202 may include one or more processors to execute instructions to complete all or part of the methods described above. In addition, the processing component 202 may include one or more modules to facilitate interactions between the processing component 202 and other components. For example, the processing component 202 may include a multimedia module to facilitate interaction between the multimedia component 208 and the processing component 202.

The memory 204 is configured to store various types of data to support operations in the device 200. Examples of such data include instructions, contact data, phone book data, messages, pictures, videos, and the like for any application or method operating on the device 200. The memory 204 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The power component 206 provides power for various components of the device 200. The power component 206 may include a power management system, one or more power supplies, and other components associated with generating, managing, and distributing power for the device 200.

The multimedia component 208 includes a display screen providing an output interface between the device 200 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some embodiments, the multimedia component 208 includes a front camera and/or a rear camera. When the device 200 is in operation mode, such as shooting mode or video mode, the front camera and/or rear camera can receive external multimedia data. Each front camera and rear camera can be a fixed optical lens system or have focal length and optical zoom capability.

The audio component 210 is configured to output and/or input audio signals. For example, the audio component 210 includes a microphone (MIC), which is configured to receive an external audio signal when the device 200 is in an operation mode, such as a calling mode, a recording mode, and a voice recognition mode. The received audio signal may be further stored in memory 204 or transmitted via communication component 216. In some embodiments, the audio component 210 also includes a speaker for outputting audio signals.

The I/O interface 212 provides an interface between the processing component 202 and peripheral interface modules, which can be a keyboard, click wheel, button, etc. These buttons may include, but are not limited to, the Home button, Volume button, Start button, and Lock button.

The sensor component 214 includes one or more sensors for providing various aspects of condition evaluation for the device 200. For example, the sensor component 214 can detect an open/closed state of the device 200, relative positioning of the components. The component is, for example, a display and a keypad of the device 200. The sensor component 214 can also detect changes in the position of the device 200 or one component of the device 200, presence or absence of the user's contact with the device 200, orientation or acceleration/deceleration of the device 200 and temperature change of the device 200. The sensor component 214 may include a proximity sensor configured to detect the presence of nearby objects without any physical contact. The sensor component 214 may also include a light sensor, such as a CMOS or CCD image sensor, for use in imaging applications. In some embodiments, the sensor component 214 may also include an acceleration sensor, a gyroscope sensor, a magnetic sensor, a pressure sensor, or a temperature sensor.

The communication component 216 is configured to facilitate wired or wireless communication between the device 200 and other devices. The device 200 can access wireless networks based on any communication standards, such as WiFi, 2G or 3G, or a combination thereof. In some embodiments, the communication component 216 receives a broadcast signal or broadcast related information from an external broadcast management system via a broadcast channel. In some embodiments, the communication component 216 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some embodiments, the device 200 can be implemented through one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for implementing above methods.

In some embodiments, a non-transitory computer-readable storage medium including instructions is also provided, such as a memory 204 including instructions, which can be executed by a processor of the device 200 to complete above methods. For example, the non-transitory computer-readable storage medium can be ROM, random access memory (RAM), CD-ROM, tapes, floppy disks, optical data storage devices, etc.

It should be further understood that “multiple” in the present disclosure refers to two or more, and other quantifiers are similar. “And/or” describes an association relationship between associated objects, indicating that there can be three relationships. For example, A and/or B can indicate that A alone, both A and B, or B alone. The character “/” generally indicates that the associated objects have an “or” relationship. The singular forms “one”, “a” and “the” are also intended to include majority forms, unless the context clearly indicates otherwise.

It should be further understood that the terms “first”, “second” and the like are used to describe various kinds of information, but these information should not be limited to these terms. These terms are only used to distinguish the same type of information from each other, and do not indicate a specific order or importance. In fact, the expressions “first” and “second” can be used interchangeably. For example, without departing from the scope of the present disclosure, the first information can also be referred to as the second information, and similarly, the second information can also be referred to as the first information.

It should be further understood that although the operations in embodiments of the present disclosure are described in a specific order in the drawings, they should not be understood that these operations are required to be performed in the specific order or serial order shown, or that all of the operations shown are required to be performed to achieve the desired results. Multitasking and parallel processing may be advantageous in a particular environment.

After considering the specification and practices of the invention disclosed herein, those skilled in the art will easily come up with other implementation solutions of the present disclosure. The present disclosure aims to cover any variations, uses, or adaptive changes of the present disclosure, which follow the general principles of the present disclosure and include common knowledge or commonly used technical means in the art that are not disclosed in the present disclosure. The specification and embodiments are only considered exemplary, and the true scope and spirit of the present disclosure are defined by appended claims.

It should be understood that the present disclosure is not limited to the precise structure described above and shown in the drawings, and various modifications and changes can be made without departing from its scope. The scope of the present disclosure is limited only by the appended claims.

1. A resource allocation method, performed by a first user device, comprising:
sending first reserved resource indication information, wherein the first reserved resource indication information is configured to indicate a first reserved resource, and the first reserved resource is a reserved resource used by the first user device for subsequent sending of a Sidelink ranging signal.

2. The resource allocation method according to claim 1, wherein sending the first reserved resource indication information comprises:
sending the first reserved resource indication information based on Sidelink Control Information, SCI.

3. The resource allocation method according to claim 2, wherein sending the first reserved resource indication information based on the SCI comprises:
sending the first reserved resource indication information based on first SCI, wherein the first SCI comprises a first information field and a second information field, the first information field is configured to carry the first reserved resource indication information, and the second information field is configured to carry communication control information for Physical Sidelink Shared Channel, PSSCH, data transmission.

4. The resource allocation method according to claim 3, wherein the first information field comprises a reserved bit in the first SCI.

5. The resource allocation method according to claim 3, wherein the reserved resource is explicitly or implicitly indicated through at least one of:
the bit comprised in the first information field;
a time-frequency resource position of Physical Sidelink Control Channel, PSCCH, for transmitting the first SCI;
a time-frequency resource position of PSSCH associated with the PSCCH for transmitting the first SCI;
a time-frequency resource of the PSSCH for transmitting the first SCI; and
a reserved time-frequency resource position for data transmission in the first SCI.

6. The resource allocation method according to claim 2, wherein sending the first reserved resource indication information based on the SCI comprises:
sending the first reserved resource indication information based on second SCI, wherein the second SCI is SCI dedicated to indicating Sidelink ranging.

7. The resource allocation method according to claim 6, wherein
the second SCI and third SCI have the same Sidelink transmission channel formats, and the second SCI and the third SCI multiplex the same time and frequency resources; or
the second SCI and the third SCI have the same Sidelink transmission channel formats, and the second SCI and the third SCI use different time and frequency resources;
wherein the third SCI is SCI configured to indicate PSSCH data transmission.

8. (canceled)

9. The resource allocation method according to claim 2, wherein the SCI comprises 1st-stage SCI and/or 2nd-stage SCI.

10. The resource allocation method according to claim 1, wherein sending the first reserved resource indication information comprises:
sending the first reserved resource indication information based on Media Access Control Control Unit, MAC CE.

11. The resource allocation method according to claim 1, further comprising:
receiving second reserved resource indication information sent by a second user device, wherein the second user device is another device sending the Sidelink ranging signal different from the first user device, the second reserved resource indication information is configured to indicate a second reserved resource, and the second reserved resource is a reserved resource used by the second user device for subsequent sending of the Sidelink ranging signal; and
determining a resource different from the second reserved resource as the first reserved resource.

12. (canceled)

13. A resource allocation device, comprising:
a processor; and
a memory for storing instructions executable by the processor;
wherein the processor is configured to:
send first reserved resource indication information, wherein the first reserved resource indication information is configured to indicate a first reserved resource, and the first reserved resource is a reserved resource used by the first user device for subsequent sending of a Sidelink ranging signal.

14. (canceled)

15. The resource allocation device according to claim 13, wherein the processor is further configured to:
send the first reserved resource indication information based on Sidelink Control Information, SCI.

16. The resource allocation device according to claim 15, wherein the processor is further configured to:
send the first reserved resource indication information based on first SCI, wherein the first SCI comprises a first information field and a second information field, the first information field is configured to carry the first reserved resource indication information, and the second information field is configured to carry communication control information for Physical Sidelink Shared Channel, PSSCH, data transmission.

17. The resource allocation device according to claim 16, wherein the first information field comprises a reserved bit in the first SCI.

18. The resource allocation device according to claim 17, wherein the reserved resource is explicitly or implicitly indicated through at least one of:
the bit comprised in the first information field;
a time-frequency resource position of Physical Sidelink Control Channel, PSCCH, for transmitting the first SCI;
a time-frequency resource position of PSSCH associated with the PSCCH for transmitting the first SCI;
a time-frequency resource of the PSSCH for transmitting the first SCI; and
a reserved time-frequency resource position for data transmission in the first SCI.

19. The resource allocation device according to claim 15, wherein the processor is further configured to:
send the first reserved resource indication information based on second SCI, wherein the second SCI is SCI dedicated to indicating Sidelink ranging.

20. The resource allocation device according to claim 19, wherein
the second SCI and third SCI have the same Sidelink transmission channel formats, and the second SCI and the third SCI multiplex the same time and frequency resources; or
the second SCI and the third SCI have the same Sidelink transmission channel formats, and the second SCI and the third SCI use different time and frequency resources;
wherein the third SCI is SCI configured to indicate PSSCH data transmission.

21. The resource allocation device according to claim 15, wherein the SCI comprises 1st-stage SCI and/or 2nd-stage SCI.

22. The resource allocation device according to claim 13, wherein the processor is further configured to:
send the first reserved resource indication information based on Media Access Control Control Unit, MAC CE.

23. The resource allocation device according to claim 13, wherein the processor is further configured to:
receive second reserved resource indication information sent by a second user device, wherein the second user device is another device sending the Sidelink ranging signal different from the first user device, the second reserved resource indication information is configured to indicate a second reserved resource, and the second reserved resource is a reserved resource used by the second user device for subsequent sending of the Sidelink ranging signal; and
determine a resource different from the second reserved resource as the first reserved resource.
